(19) United States
(12) Patent Application Publication
(10) Pub. No.: US 2020/0017978 A1
(43) Pub. Date: Jan. 16, 2020

(54) COMPOSITION FOR CLEANING MASK AND METHOD FOR CLEANING MASK USING THE SAME

(71) Applicant: SOULBRAIN CO., LTD., Seongnam-si (KR)

(72) Inventors: Gil Ho LEE, Seongnam-si (KR); Chang Ho LEE, Seongnam-si (KR); Sang-Ho AN, Seongnam-si (KR); Soon Min PARK, Seongnam-si (KR); Hong Sik KIM, Seongnam-si (KR)

(21) Appl. No.: 16/195,800

(22) Filed: Nov. 19, 2018

(30) Foreign Application Priority Data
Jul. 13, 2018 (KR) 10-2018-0081862

(51) Int. Cl. C23G 1/14; B08B 7/04; B08B 7/02; C11D 7/06; C11D 7/10

(52) U.S. Cl. CPC C23G 1/14; B08B 7/04; C11D 7/10; C11D 7/06; C11D 7/105; B08B 7/028

(57) ABSTRACT

The present invention provides a composition for cleaning a mask comprising a) 0.2 to 10% by weight of two or more alkali compounds selected from alkali hydroxides and alkali carbonates, b) 0.1 to 8% by weight of nitrate, c) 1 to 8% by weight of an oxidizer, and d) residual water, wherein the pH is 11.5 to 14.

According to the present invention, a composition for cleaning a mask and a method for cleaning a mask using the same, which can remove only the film deposited on the mask in a short time without damaging the mask, was provided.

### CROSS-REFERENCE TO RELATED APPLICATIONS

This application claims priority under 35 U.S.C. § 119 to Korean Patent Application No. 10-2018-0081862, filed on Jul. 13, 2018, in the Korean Intellectual Property Office, the disclosure of which is incorporated herein by reference in its entirety.

### TECHNICAL FIELD

The following disclosure relates to a composition for cleaning a mask and a method for cleaning a mask using the same, and more particularly, to a composition for cleaning a mask, which removes only a film deposited on the mask in a short time without damaging the mask during the cleaning process, and a method for cleaning a mask using the same.

### BACKGROUND

In display devices, in consideration of electrical characteristics and the like, a metal wiring with a stacked metal thin film is formed on a substrate. The metal thin film is generally formed by depositing a metal substance on a substrate using a mask. During deposition of the metal substance, the metal substance is deposited even on the surface of the mask, and thus, after a predetermined number of processes, the mask should be cleaned to remove foreign substances such as the metal substance deposited on the mask.

A general mask cleaning method is a method in which a mask with foreign substances deposited thereon is immersed in a cleaning bath including a cleaning composition. When the mask is immersed in the cleaning bath, the foreign substances deposited on the mask are removed by being dissolved in the cleaning composition. However, when the foreign substances are metal substances, a cleaning composition capable of removing the metal substances must be utilized, wherein there is a problem in that the mask, made of a metal material, is also dissolved rather than selectively removing the foreign substances only.

Further, since masks made of metal are expensive consumable materials, the masks can be used for a long period of time only when foreign substances can be removed without damaging the mask in the cleaning process.

Conventionally, masks have been cleaned by applying different cleaning compositions depending on the type of metal materials (foreign substances) deposited on the mask, which has problems in that the process is cumbersome and the cleaning time is long.

Therefore, there is a need for a cleaning composition capable of cleaning a metal thin film while preventing damage to a mask by using a single cleaning composition.

### SUMMARY

An embodiment of the present invention is directed to providing a composition for cleaning a mask, which removes only a deposited film in a short time without damaging the mask during the cleaning process, and a method for cleaning a mask using the same.

The object of the present invention can be achieved by the present invention, as described below.

To achieve the objects of the present invention, the present invention provides a composition for cleaning a mask comprising: a) 0.2 to 10% by weight of two or more alkali compounds selected from alkali hydroxides and alkali carbonates, b) 0.1 to 8% by weight of nitrate, c) 1 to 8% by weight of an oxidizer, and d) residual water, wherein the pH is 11.5 to 14.

In addition, the present invention provides a method for cleaning a mask comprising steps of: i) preparing a composition for cleaning a mask, the composition comprising: a) 0.2 to 10% by weight of two or more alkali compounds selected from alkali hydroxides and alkali carbonates, b) 0.1 to 8% by weight of nitrate, c) 1 to 8% by weight of an oxidizer, and d) residual water, wherein pH is 11.5 to 14; and ii) cleaning a mask on which one or more selected from the group consisting of a metal film, including one or more of silver and magnesium, and an aluminum oxide film are deposited, using the composition for cleaning a mask.

### BRIEF DESCRIPTION OF THE DRAWINGS

FIG. 1 is a scanning electron microscopy (SEM) image of a mask cleaned using a composition for cleaning a mask prepared in Example 1.

FIG. 2 is a scanning electron microscopy (SEM) image of a mask cleaned using a composition for cleaning a mask prepared in Comparative Example 1.

FIG. 3 is a scanning electron microscopy (SEM) image of a mask cleaned using a composition for cleaning a mask prepared in Comparative Example 7.

### DETAILED DESCRIPTION OF EMBODIMENTS

Hereinafter, a composition for cleaning a mask according to the present invention and a method for cleaning a mask using the composition are described in detail.

The present inventors steadily studied the cleaning of a mask on which one or more selected from the group consisting of a metal film, including one or more of silver and magnesium, and an aluminum oxide (Al₂O₃) film were deposited, using just a single cleaning composition. As a result, it was found that when the content of an oxidizer in the cleaning composition increased, the pH of the composition decreased, and thus it was difficult to clean an aluminum oxide film which is only capable of being cleaned in the strong alkaline region, but when two or more predetermined alkaline compounds were added and mixed in the composition for cleaning a mask, the strong alkalinity of the composition was maintained, and thus it was possible to clean only the film in a short time without damaging the mask, and the present inventors thereby completed the present invention based on these findings.

The composition for cleaning a mask of the present invention may comprise: a) 0.2 to 10% by weight of two or more alkali compounds selected from alkali hydroxides and alkali carbonates, b) 0.1 to 8% by weight of nitrate, c) 1 to 8% by weight of an oxidizer, and d) residual water, wherein the pH is 11.5 to 14. In this case, only the film deposited on the mask can be cleaned in a short time without damaging the mask.

For example, the composition may be used for cleaning a mask on which one or more selected from a metal film, including one or more of silver and magnesium, and an aluminum oxide (Al₂O₃) film are deposited. In this case, the film of the present invention can be cleaned in a short time without damaging the mask.

The metal film may be, for example, a silver-based metal film, a magnesium-based metal film, an alloy film of silver and magnesium, or a metal film with a multilayer structure in which two or more thereof are stacked.

The metal film with a multilayer structure may have a structure in which a silver-based metal film is a lower film and a magnesium-based metal film is an upper film. Conversely, the metal film may also have a structure in which the magnesium-based metal film is a lower film and the silver-based metal film is an upper film. As another example, the metal film may have a structure of a layered film with three or more layers, four or more layers, or three to five layers, in which the silver metal-based films and the magnesium-based metal films are alternately stacked.

The silver-based metal film may be, for example, a silver film or an alloy film of silver and another metal (excluding magnesium). In the present invention, the silver alloy is an alloy comprising silver as the main component. For example, based on 100% by weight of the total weight of the alloy, the content of silver may be the largest, and specifically, 50% by weight or more, or in other words, exceeding 50% by weight.

The alloy film of silver and magnesium may have a weight ratio of silver and magnesium of 6:4 to 9.9:0.1 (silver:magnesium) or 8:2 to 9:1 (silver:magnesium). In this case, the alloy film of silver and magnesium can be removed completely by using the composition for cleaning a mask of the present invention.

The magnesium-based metal film may be, for example, a magnesium film or an alloy film of magnesium and another metal (excluding silver). In the present invention, the magnesium alloy is an alloy comprising magnesium as the main component. For example, based on 100% by weight of the total weight of the alloy, the content of magnesium may be the largest, and specifically, 50% by weight or more, or in other words, exceeding 50% by weight.

The alloy film of magnesium and silver may have a weight ratio of magnesium and silver of 6:4 to 9.9:0.1 (magnesium:silver) or 6:4 to 7:3 (magnesium:silver). In this case, the alloy film of magnesium and silver can be removed completely by using the composition for cleaning a mask of the present invention.

The material of the mask may be, for example, one or more metals selected from stainless steel or a nickel alloy. These metals have a low coefficient of thermal expansion, thus resulting in formation of a metal wiring with a desired shape on a substrate without the occurrence of deformation during a high temperature deposition process.

The nickel alloy may be, for example, an alloy of nickel and one or more metals selected from copper, chromium, iron, molybdenum, titanium or cobalt.

The material of the mask may be, for example, one or more alloys selected from a steel use stainless (SUS) alloy, an invariable (INVAR) alloy, and a KOVAR alloy, and may preferably be an INVAR alloy. In this case, it is possible to form a metal wiring with a desired shape on a substrate without the occurrence of deformation during a high temperature deposition process.

The SUS alloy may be, for example, an alloy of iron, nickel, and chromium. The INVAR alloy may be, for example, an alloy comprising 36% or more nickel, and may be, specifically, an alloy of nickel and iron. The KOVAR alloy may be, for example, an alloy of iron, nickel, and cobalt.

Hereinafter, the composition for cleaning a mask according to the present invention is described in detail for each component.

a) Two or More Alkaline Compounds

The two or more alkaline compounds of a) may comprise an amount of, for example, 0.2 to 10% by weight, 4 to 10% by weight, or 7 to 10% by weight based on 100% by weight of the total composition for cleaning a mask (a+b+c+d). Within this range, the damage to the mask is significantly suppressed. The two or more alkali compounds of a) may be, for example, two or more selected from the group consisting of potassium hydroxide, sodium hydroxide, and calcium hydroxide, and preferably may be a mixture of potassium hydroxide and sodium hydroxide. In this case, the strong alkalinity of the composition increases, and thus the cleaning capacity is maximized as compared to a case where only one kind of alkaline compound is used, thereby resulting in achievement of an excellent cleaning effect of a multilayer film while simultaneously minimizing the damage to the mask. As a specific example, the two or more kinds of alkali compounds of a) may include potassium hydroxide and sodium hydroxide each in an amount of from 0.1% by weight to less than 5% by weight, from 1 to 4.9% by weight or from 3 to 4.8% by weight based on 100% by weight of the total composition (a+b+c+d). Within this range, damage to the mask is minimized while simultaneously achieving an excellent cleaning effect. When the potassium hydroxide and sodium hydroxide are each contained in an amount of 5% by weight or higher, these components are regarded as toxic substances, thus making it impossible to carry out mass production.

b) Nitrate

The nitrate of b) may have an amount of, for example, 0.1 to 8% by weight, 0.5 to 5% by weight, or 1 to 3% by weight based on 100% by weight of the total composition for cleaning a mask (a+b+c+d). Within this range, the film of the present invention is dissolved excellently without damaging the mask. The nitrate of b) may be one or more selected from potassium nitrate, sodium nitrate, ammonium nitrate, calcium nitrate, aluminum nitrate, and magnesium nitrate. In this case, the film is dissolved excellently in a short time.

c) Oxidizer

The oxidizer of c) may have an amount of, for example, 1 to 8% by weight, 2 to 7% by weight, or 3 to 6% by weight based on 100% by weight of the total composition for cleaning a mask (a+b+c+d). Within this range, the surface of the film of the present invention is oxidized excellently without damaging the mask. The oxidizer of c) may be, for example, a sulfate compound. In this case, the surface of the film of the present invention is oxidized excellently in a short time without damaging the mask. The sulfate compound may be, for example, one or more selected from ammonium sulfate, ammonium persulfate, potassium hydrogensulfate, potassium peroxysulfate, sodium sulfate, and sodium persulfate. In this case, the surface of the film of the present invention is oxidized excellently in a short time.

d) Water

The water, d), may be, for example, distilled water or deionized water, preferably deionized water, and more preferably deionized water or ultrapure water with maximal reduction of impurities. The content of water in the present invention is not particularly limited, and may be, for example, a residual amount excluding the constituent components in the composition for cleaning a mask, and can be appropriately adjusted in consideration of workability, and the like, of the composition for cleaning a mask of the present invention.

The composition for cleaning a mask of the present invention may have a pH of, for example, 11.5 to 14, 12.3 to 14, 12.3 to 13.1, or 12.7 to 13.1. Within this range, the cleaning effect on the film of the present invention, particularly an aluminum oxide film, is maximized without damaging the mask. When the pH is, for example, less than 11.5, it is difficult to clean a film in the strong alkaline region, particularly the aluminum oxide film, and thus it is important to maintain the pH at 11.5 or higher.

The composition for cleaning a mask according to the present invention has an excellent cleaning effect with respect to a metal film, including one or more of silver and magnesium, and an aluminum oxide (Al₂O₃) film, with the use of only a single cleaning composition, thereby contributing to reduction of both the cleaning time and the process cost.

In the present specification, the pH may be measured using a general pH measuring apparatus at room temperature (20 to 25° C.) unless otherwise specified, and specifically, can be measured using a Thermo Scientific Orion Star A Series.

The composition for cleaning a mask of the present invention can be, for example, fluorine-based compound-free, hydrogen peroxide-free and/or inorganic acid-free. In this case, the cleaning capacity of the multilayer film of the present invention may be excellent, while simultaneously the mask may have excellent resistance to corrosion. In particular, when the composition is fluorine-based compound-free, it is possible to obtain an environment-friendly effect and to prevent damage to equipment. As used herein, the term “fluorine-based compound-free, hydrogen peroxide-free and/or inorganic acid-free” means that a fluorine-based compound, hydrogen peroxide, and/or inorganic acid are not intentionally added to the composition.

In the present invention, the cleaning capacity with respect to the Ag—Mg metal film may be, for example, 300 seconds or less, 100 to 200 seconds, or 120 to 200 seconds. Within this range, the metal film may be removed without damaging the mask. In the present invention, the cleaning capacity is defined as a measurement of the removal time of a thin film deposited on the mask. The removal of the deposited thin film from the mask can be confirmed by surface analysis of the mask, and the mask surface analysis includes primary, secondary, and tertiary surface analyses. The primary surface analysis is visual confirmation, the secondary surface analysis is a high magnification SEM analysis, and the tertiary surface analysis is SEM-EDX analysis, or more specifically, an analysis of whether or not an element is detected from the sample.

In the present invention, the cleaning capacity with respect to the aluminum oxide film may be, for example, less than 30 minutes, 10 to 25 minutes, or 15 to 25 minutes. Within this range, excellent removal of the aluminum oxide film may be achieved without damaging the mask.

The corrosion resistance of the mask in the present invention may be, for example, more than 60 minutes, one day or more, three days or more, or three to five days. Within this range, the film of the present invention may be removed excellently. In the present invention, the corrosion resistance can be measured by visually observing the degree of corrosion of a mask from which the composition for cleaning a mask of the present invention has been removed, and confirming a change in weight. The change in weight can be confirmed by using an analytical precision balance capable of measuring up to 0.0001 g.

In describing the composition for cleaning a mask of the present invention, the use of additives, and the like, which are not explicitly stated, is not particularly limited when they are included in the range generally practiced in the technical field to which the present invention pertains, and they may be selected appropriately.

The cleaning composition of the present invention may also be used for cleaning a silver-based metal, a magnesium-based metal, and aluminum oxide (Al₂O₃) which is deposited on other deposition components in addition to the mask during the deposition process. For example, the cleaning composition of the present invention may be used for washing one or more selected from silver-based metals, magnesium-based metals, and aluminum oxide (Al₂O₃), deposited on a shield, a shutter, and the like, which are components of the deposition chamber that are made of metal materials equivalent to the mask.

Hereinafter, the method for cleaning a mask according to the present invention is described in detail.

The method for cleaning a mask of the present invention may include, for example, i) a step of preparing a composition for cleaning a mask, the composition including: a) 0.2 to 10% by weight of two or more alkali compounds selected from alkali hydroxides and alkali carbonates, b) 0.1 to 8% by weight of nitrate, c) 1 to 8% by weight of an oxidizer, and d) residual water, wherein the pH is 11.5 to 14; and ii) a step of cleaning a mask on which one or more selected from a metal film, including one or more of silver and magnesium, and an aluminum oxide film are deposited, using the composition for cleaning a mask. In this case, the Ag—Mg metal film and/or the aluminum oxide film can be cleaned in a short time without damaging the mask.

In the present invention, pH control is carried out to implement the pH of the above-described composition for cleaning a mask within a specific range, and it means that the pH of the composition for cleaning a mask of the present invention is controlled to be from 11.5 to 14 through adjustment of the contents of the two or more alkaline compounds, nitrate, oxidizer, and water within the ranges not deviating from the contents of the present invention.

The step of cleaning the mask, ii), may be, for example, a method for cleaning a film deposited on a mask by immersing the mask in the composition for cleaning a mask, wherein the immersion time is not particularly limited, but may be 1 to 50 minutes, or 2 to 30 minutes, and the temperature for cleaning may be 10 to 40° C., or 20 to 30° C. Within this range, removal of the film deposited on the mask can be completed.

The step of cleaning the mask, ii), may be performed, for example, using an ultrasonic cleaner. In this case, excellent removal of the film deposited on the mask can be achieved.

The step of cleaning the mask, ii), may further include, for example, a washing step, a drying step, or both a washing and drying step. In this case, complete removal of the composition for cleaning a mask which remains on the mask after cleaning can be achieved.

The washing step may be performed, for example, using water. In this case, the composition for cleaning a mask and the film of the present invention which remains on the mask can be removed completely.

As an example, the drying step may be performed by drying the mask completely using an air gun so as to remove the water used during the washing step. In this case, the composition for cleaning a mask and the film of the present invention which remains on the mask can be removed completely.

It should be understood that the implementation of process conditions or pieces of equipment which are not disclosed herein to describe the mask cleaning method is not limited and may be selected appropriately by one with an ordinary skill in the art.

Hereinafter, desirable Examples of the present invention will be provided; however, it should be understood that the Examples provided are merely for providing a better understanding of the present invention, and various modifications or changes which can be made will be obvious to one skilled in the art. Such modifications or changes also fall within the scope of the present invention, as per the claims attached.

### EXAMPLE

### Example 1

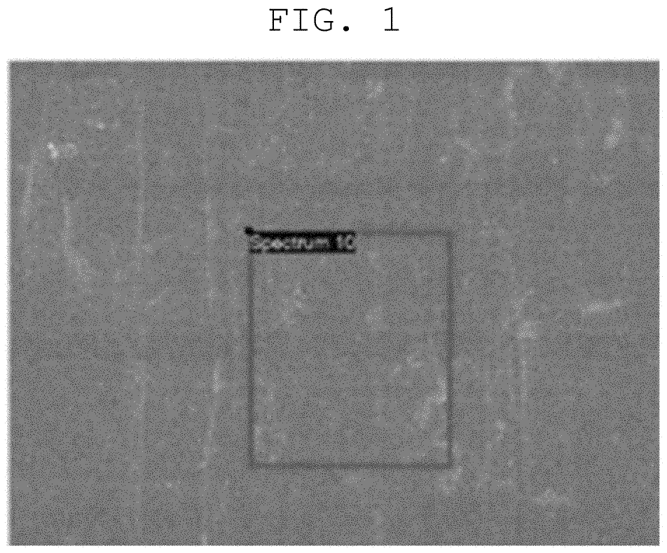

A cleaning liquid including 4.8 wt % of sodium hydroxide, 4.8% by weight of potassium hydroxide, 3% by weight of sodium nitrate as a nitrate, 6% by weight of oxone as an oxidizer, and the remaining amount of water was stirred at a speed of 300 to 700 rpm to prepare a composition for cleaning a mask. Next, an INVAR alloy mask on which an Ag—Mg metal film and/or an aluminum oxide film was deposited was immersed in an ultrasonic cleaner including the prepared composition for cleaning mask for 30 minutes, and then washed with ultrapure water. After completion of the washing step, the mask was completely dried using an air gun. FIG. 1 shows a scanning electron microscopy (SEM) image of a mask cleaned using the composition for cleaning a mask prepared in Example 1.

### Example 2

Example 2 was performed in the same manner as in Example 1 except that the oxidizer was used in an amount of 3% by weight.

### Example 3

Example 3 was performed in the same manner as in Example 1 except that the nitrate was used in an amount of 1% by weight.

### Example 4

Example 4 was performed in the same manner as in Example 1 except that the sodium hydroxide was used in an amount of 3% by weight.

### Comparative Example 1

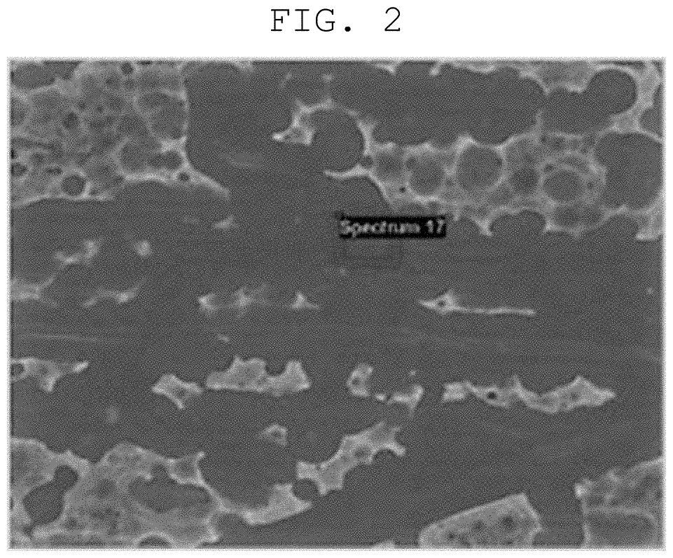

Comparative Example 1 was performed in the same manner as in Example 1 except that the sodium hydroxide was not used. FIG. 2 shows a scanning electron microscopy (SEM) image of a mask cleaned using the composition for cleaning a mask prepared in Comparative Example 1.

### Comparative Example 2

Comparative Example 2 was performed in the same manner as in Example 1 except that the potassium hydroxide was used in an amount of 6% by weight.

### Comparative Example 3

Comparative Example 3 was performed in the same manner as in Example 1 except that the nitrate was used in an amount of 10% by weight.

### Comparative Example 4

Comparative Example 4 was performed in the same manner as in Example 1 except that the nitrate was used in an amount of 0.05% by weight.

### Comparative Example 5

Comparative Example 5 was performed in the same manner as in Example 1 except that the oxidizer was used in an amount of 10% by weight.

### Comparative Example 6

Comparative Example 5 was performed in the same manner as in Example 1 except that the oxidizer was used in an amount of 0.5% by weight.

### Comparative Example 7

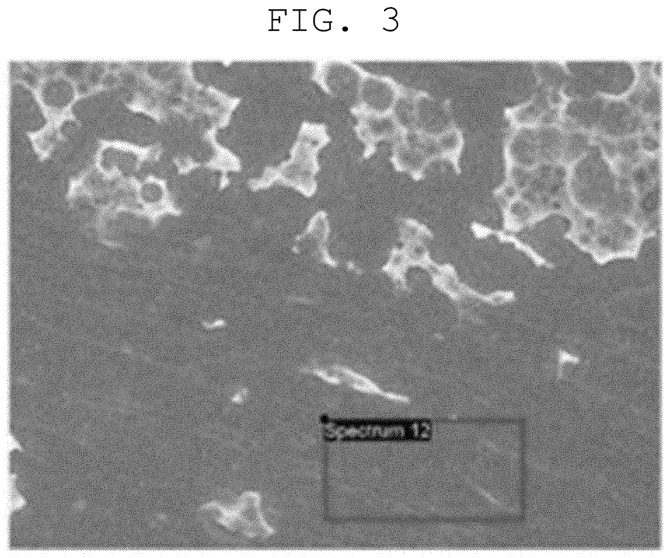

Comparative Example 7 was performed in the same manner as in Example 1 except that potassium hydroxide was not used. FIG. 3 shows a scanning electron microscopy (SEM) image of a mask cleaned using the composition for cleaning a mask prepared in Comparative Example 7.

### Reference Example 1

Reference Example 1 was performed in the same manner as in Example 1 except that 1.0% by weight of NH4F, which is a fluorine compound, was further included.

### Reference Example 2

Reference Example 2 was performed in the same manner as in Example 1 except that 1.0% by weight of hydrogen peroxide was further included.

### Reference Example 3

Reference Example 3 was performed in the same manner as in Example 1 except that 1.0% by weight of nitric acid was further included.

### Test Example

Properties of the masks cleaned using the compositions for cleaning a mask prepared in Examples 1 to 4, Comparative Examples 1 to 7, and Reference Examples 1 to 3 were measured by the following methods, and the results are shown in Table 2 below.
pH: The pH was measured using a Thermo Scientific Orion Star A Series, which is a pH meter.
Cleaning capacity: The removal time of the thin film deposited on the mask was measured, and it was confirmed that the deposited thin film was removed from the mask through the mask surface analysis.

Primary surface analysis: Visual observation.

Secondary surface analysis: High magnification SEM analysis.

Tertiary surface analysis: SEM-EDX analysis, which is an analysis of whether or not an element is detected.
Mask corrosion evaluation: The degree of corrosion of a mask, from which the composition for cleaning a mask was already removed, was observed visually, and the change in weight was confirmed. The change in weight was confirmed using an analytical precision balance.

∘: Severe corrosion Δ: Some corrosion X: No corrosion at all

TABLE 1

| | Potassium | Sodium | | | | Hydrogen | Nitric |
|---|---|---|---|---|---|---|---|
| | hydroxide | hydroxide | Nitrate | Oxidizer | NH4F | peroxide | acid |
| | (wt %) | (wt %) | (wt %) | (wt %) | (wt %) | (wt %) | (wt %) |
| Example 1 | 4.8 | 4.8 | 3 | 6 | — | — | — |
| Example 2 | 4.8 | 4.8 | 3 | 3 | — | — | — |
| Example 3 | 4.8 | 4.8 | 1 | 6 | — | — | — |
| Example 4 | 4.8 | 3 | 3 | 6 | — | — | — |
| Comparative | 4.8 | — | 3 | 6 | — | — | — |
| Example 1 | | | | | | | |
| Comparative | 6 | 4.8 | 3 | 6 | — | — | — |
| Example 2 | | | | | | | |
| Comparative | 4.8 | 4.8 | 10 | 6 | — | — | — |
| Example 3 | | | | | | | |
| Comparative | 4.8 | 4.8 | 0.05 | 6 | — | — | — |
| Example 4 | | | | | | | |
| Comparative | 4.8 | 4.8 | 3 | 10 | — | — | — |
| Example 5 | | | | | | | |
| Comparative | 4.8 | 4.8 | 3 | 0.5 | — | — | — |
| Example 6 | | | | | | | |
| Comparative | — | 4.8 | 3 | 6 | — | — | — |
| Example 7 | | | | | | | |
| Reference | 4.8 | 4.8 | 3 | 6 | 1.0 | — | — |
| Example 1 | | | | | | | |
| Reference | 4.8 | 4.8 | 3 | 6 | — | 1.0 | — |
| Example 2 | | | | | | | |
| Reference | 4.8 | 4.8 | 3 | 6 | — | — | 1.0 |
| Example 3 | | | | | | | |

TABLE 2

| | | Ag—Mg Metal Film | Al2O3 Film | | | | |
|---|---|---|---|---|---|---|---|
| | | Cleaning | Cleaning | Mask Corrosiveness | | | Mass |
| | pH | Capacity | Capacity | 60 min | 1 day | 3 days | Productivity |
| Example 1 | 12.9 | 120 sec | 15 min | x | x | x | ∘ |
| Example 2 | 13.1 | 180 sec | 20 min | x | x | x | ∘ |
| Example 3 | 13 | 200 sec | 20 min | x | x | x | ∘ |
| Example 4 | 12.3 | 190 sec | 25 min | x | x | x | ∘ |
| Comparative | 12 | 130 sec | 30 min | x | x | x | ∘ |
| Example 1 | | | | | | | |
| Comparative | 13.3 | 120 sec | 15 min | x | x | x | x |
| Example 2 | | | | | | | |
| Comparative | 12.5 | 110 sec | 20 min | x | x | ∘ | ∘ |
| Example 3 | | | | | | | |
| Comparative | 13.2 | 1200 sec | 10 min | x | x | x | ∘ |
| Example 4 | | | | | | | |
| Comparative | 12.4 | 110 sec | 20 min | x | x | ∘ | ∘ |
| Example 5 | | | | | | | |
| Comparative | 13.2 | 3600 sec | 40 min | x | x | x | ∘ |
| Example 6 | | | | | | | |
| Comparative | 12.2 | 130 sec | 25 min | x | x | x | ∘ |
| Example 7 | | | | | | | |
| Reference | 12.7 | 110 sec | 15 min | ∘ | ∘ | ∘ | ∘ |
| Example 1 | | | | | | | |
| Reference | 12.7 | 110 sec | 15 min | x | ∘ | ∘ | ∘ |
| Example 2 | | | | | | | |
| Reference | 10.9 | 110 sec | 20 min | ∘ | ∘ | ∘ | ∘ |
| Example 3 | | | | | | | |

As shown in Table 1, when the mask with the Ag—Mg metal film and/or Al₂O₃ film deposited thereon was cleaned using the compositions for cleaning a mask of the present invention (Examples 1 to 4), it could be confirmed that it was possible to remove only the Ag—Mg metal film and the Al₂O₃ film within a short time without damaging the mask.

On the other hand, in Comparative Examples 1 and 7, which included one kind of alkaline compound rather than two or more alkaline compounds, it could be confirmed that the composition had a low pH, thus leading to deterioration of the cleaning capacity with respect to the Al₂O₃ film.

Further, in Comparative Example 2, including 5% by weight or more of one kind of alkaline compound, it could be confirmed that the composition was treated as a toxic substance, thus resulting in failure to meet the requirements for mass production, and further, while the content of potassium hydroxide increased as compared to Example 1, the cleaning capacity with respect to the film was not improved.

In addition, when the content of the nitrate or oxidizer exceeded the content range of the present invention (Comparative Examples 3 and 5), it could be confirmed that the resistance to corrosion was deteriorated, thus resulting in severe corrosion of the mask after 3 days of cleaning.

Further, when the content of the nitrate or oxidizer was less than the content range of the present invention (Comparative Examples 4 and 6), it could be confirmed that the cleaning capacity with respect to the Ag—Mg metal film was very deteriorated, and in particular, when the content of the oxidizer was small as in Comparative Example 6, significant deterioration of the cleaning capacity with respect to the Al₂O₃ film also occurred.

In addition, it could be confirmed that in Reference Examples 1 to 3, which included a fluorine-based compound, hydrogen peroxide, and an inorganic acid, respectively, the corrosion of the mask was significant.

Further, as shown in FIGS. 1, 2 and 3, it could be confirmed that when the mask was cleaned using the composition for cleaning a mask of the present invention (FIG. 1), the dark portion, which is the portion where cleaning was completed, was larger than that of the cases where only one kind of alkaline compound was used (FIGS. 2 and 3), and thus it could be confirmed that when the mask was cleaned using the composition for cleaning a mask including two or more alkaline compounds (Example 1), the cleaning effect on the mask was superior to that in the case where the mask was cleaned using the composition for cleaning a mask including one kind of alkaline compound (Comparative Examples 1 and 7).

According to the present invention, it is possible to remove only the film deposited on the mask in a short time without damaging the mask using only a single cleaning composition when cleaning the mask, which can ultimately contribute to improvement of the efficiency of the cleaning process and reduction of the process cost.

What is claimed is:

1. A composition for cleaning a mask comprising:
a) 0.2 to 10% by weight of two or more alkali compounds selected from alkali hydroxides and alkali carbonates,
b) 0.1 to 8% by weight of nitrate,
c) 1 to 8% by weight of an oxidizer, and
d) residual water,
wherein the pH is 11.5 to 14.

2. The composition for cleaning a mask of claim 1, wherein the composition is used for cleaning a mask on which one or more selected from a metal film including one or more of silver and magnesium; and an aluminum oxide (Al₂O₃) film are deposited.

3. The composition for cleaning a mask of claim 1, wherein the material of the mask is one or more metals selected from stainless steel or a nickel alloy.

4. The composition for cleaning a mask of claim 3, wherein the material of the mask is one or more alloys selected from a steel use stainless (SUS) alloy, an invariable (INVAR) alloy, and a KOVAR alloy.

5. The composition for cleaning a mask of claim 1, wherein a) two or more alkali compounds comprises potassium hydroxide and sodium hydroxide.

6. The composition for cleaning a mask of claim 5, wherein a) the potassium hydroxide and sodium hydroxide have an amount of 0.1 to 5% by weight based on 100% by weight of the total weight of the composition for cleaning a mask (a+b+c+d).

7. The composition for cleaning a mask of claim 1, wherein b) nitrate is one or more selected from potassium nitrate, sodium nitrate, ammonium nitrate, calcium nitrate, aluminum nitrate, and magnesium nitrate.

8. The composition for cleaning a mask of claim 1, wherein c) oxidizer is a sulfate compound.

9. The composition for cleaning a mask of claim 8, wherein the sulfate compound is one or more selected from ammonium sulfate, ammonium persulfate, potassium hydrogensulfate, potassium peroxysulfate, sodium sulfate, and sodium persulfate.

10. The composition for cleaning a mask of claim 8, wherein the composition is fluorine-based compound-free, hydrogen peroxide-free and/or inorganic acid-free.

11. A method for cleaning a mask comprising:
i) preparing a composition for cleaning a mask, the composition including: a) 0.2 to 10% by weight of two or more alkali compounds selected from alkali hydroxides and alkali carbonates, b) 0.1 to 8% by weight of nitrate, c) 1 to 8% by weight of an oxidizer, and d) residual water, wherein the pH is 11.5 to 14; and
ii) cleaning a mask on which one or more, selected from a metal film including one or more of silver and magnesium, and an aluminum oxide film, are deposited, using the composition for cleaning a mask.

12. The method for cleaning a mask of claim 11, wherein the step ii) of cleaning the mask includes a washing step; a drying step; or both of the washing step and the drying step.

13. The method for cleaning a mask of claim 11, wherein the step ii) of cleaning the mask is performed using an ultrasonic cleaner.
